(19) United States
(12) Patent Application Publication
(10) Pub. No.: US 2019/0276993 A1
(43) Pub. Date: Sep. 12, 2019

(54) Trenching Assembly

(71) Applicant: The Charles Machine Works, Inc., Perry, OK (US)

(72) Inventor: Cody L. Sewell, Perry, OK (US)

(21) Appl. No.: 16/426,868

(22) Filed: May 30, 2019

Related U.S. Application Data
(63) Continuation of application No. 15/290,704, filed on Oct. 11, 2016.
(60) Provisional application No. 62/261,134, filed on Nov. 30, 2015.
(60) Provisional application No. 62/245,705, filed on Oct. 23, 2015.
(60) Provisional application No. 62/239,564, filed on Oct. 9, 2015.

(51) Int. Cl. E01C 23/09; B28D 1/18

(52) U.S. Cl. CPC E01C 23/0933; E01C 2301/50; B28D 1/18; B28D 1/188

(57) ABSTRACT

An apparatus for cutting a trench is formed from a housing and a cutting assembly at least partially positioned within the housing. The cutting assembly has a cutting wheel and a plurality of teeth extending from the periphery of the cutting wheel. The cutting wheel features a plurality of layers of cylindrical profile in which at least two of the layers have profiles with different diametrical dimensions. At least some of the teeth are positioned on different layers. A trench is formed by placing the apparatus on a surface of the ground and pushing or pulling the apparatus while the cutting assembly is rotated. In one configuration, at least one layer having a profile of larger diametrical dimension is situated between a pair of layers having profiles of smaller diametrical dimension. In such configuration, the apparatus cuts a t-shaped trench.

### FIELD

The invention relates to tools and methods for cutting trenches in a surface of the ground.

### SUMMARY

An apparatus is formed from a housing and a cutting assembly at least partially positioned within the housing. The housing has a ground-engaging base in which an opening is formed. The cutting assembly has a cutting wheel and a plurality of teeth extending from the periphery of the cutting wheel. The cutting wheel is formed from a plurality of layers of cylindrical profile in which at least two of the layers have profiles with different diametrical dimensions. At least some of the teeth are positioned on the different layers.

An apparatus is also formed from a housing having a pair of first and second spaced side walls. Each side wall has an outer surface and an inner surface. The first side wall has an outer slot opening formed in the outer surface and an inner slot opening formed in the inner surface. A slot extends through the first side wall between the outer slot opening and the inner slot opening. A plate is adjustably positioned over the outer slot opening. The plate is characterized by a raised position in which the plate uncovers a portion of the outer slot opening. The plate is further characterized by a lowered position in which the plate covers the portion of the outer slot opening. A motor assembly is supported on the plate. A cutting assembly is connected to the motor assembly. The cutting assembly is at least partially positioned within the housing. A retractable cover extends over at least a portion of the outer slot opening when the plate is in the raised position.

An apparatus is also formed from a housing and a cutting assembly at least partially positioned within the housing. The housing has a pair of opposed ends. Each end has a coupler in which the couplers are formed as mirror images with respect to a plane that extends through the housing.

### BRIEF DESCRIPTION OF THE DRAWINGS

FIG. 1 is a perspective view of a cutting assembly partially positioned within a housing.

FIG. 2 is a side elevation view of the cutting assembly and housing of FIG. 1.

FIG. 3 is a partial cross-sectional view of the housing of FIG. 1.

FIG. 4 is a perspective view of a trenching assembly showing another embodiment of the cutting assembly.

FIG. 5 is a side elevation view of the cutting assembly of FIG. 4.

FIG. 6 is a perspective view of the cutting assembly of FIG. 4.

FIG. 7 is a front elevation view of the cutting assembly of FIG. 4.

FIG. 8 is a front elevation view of two of the layers of the cutting assembly of FIG. 7.

FIG. 9 is a perspective view of a trenching assembly.

FIG. 10 is a side elevation view of the trenching assembly of FIG. 8 showing a plate in a lowered position.

FIG. 11 is a side elevation view of the trenching assembly of FIG. 8 showing the plate in a raised position utilizing a cover.

FIG. 12 is a system for cutting a t-shaped trench into the ground.

### DETAILED DESCRIPTION

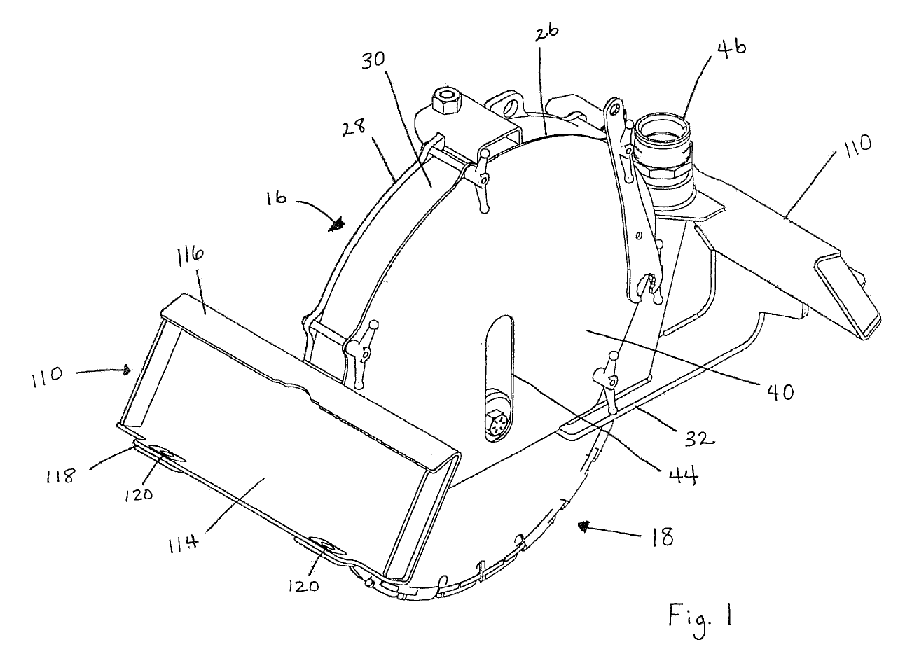

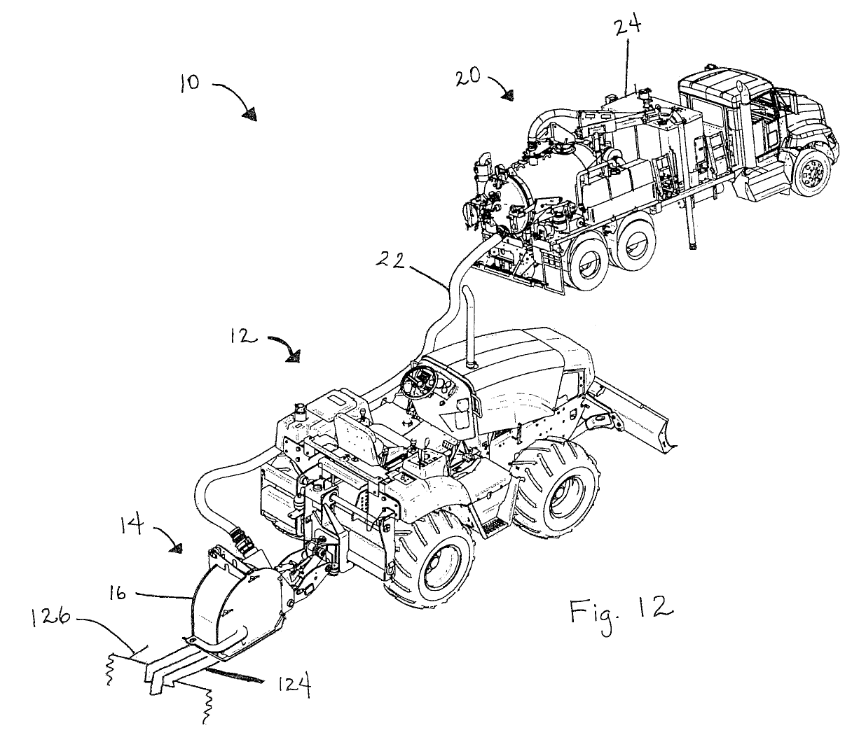

Shown in FIG. 12 is a system to for cutting a narrow trench of varying depths and widths in a surface such as a concrete or asphalt roadway. The system to comprises a work machine 12 and a trenching assembly 14 attached to the work machine 12. The trenching assembly 14 comprises a housing 16 and a cutting assembly 18 (FIG. 1) rotatably positioned within the housing 16. The trenching assembly 14 attaches to the work machine 12 via a linkage assembly. The work machine 12 may be any common tractor or work vehicle that can support the trenching assembly 14. The work machine 12 shown in FIG. 12 comprises a tractor having wheels. However, the work machine 12 may be a tracked vehicle.

The system to further comprises a vacuum system 20. The vacuum system 20 comprises a vacuum hose 22 and a vacuum power unit 24. The vacuum hose 22 is attached to the trenching assembly 14. The vacuum system 20 may be mounted on the work machine 12 or the vacuum system 20 may be mounted on another vehicle. The vacuum system 20 may comprise a cyclonic filtration system to filter fine dust and increase power unit life.

Referring to FIGS. 1-4, the housing 16 of the trenching assembly 14 is formed from a strong and durable material, such as steel. The housing 16 has a first side wall 26, a second side wall 28, an upper wall 30, and a lower wall 32 positioned such that the walls form an internal cavity. The first and second side walls 26, 28 are spaced apart and parallel to each other. The housing's upper and lower walls 30, 32 extend between the spaced side walls 26, 28.

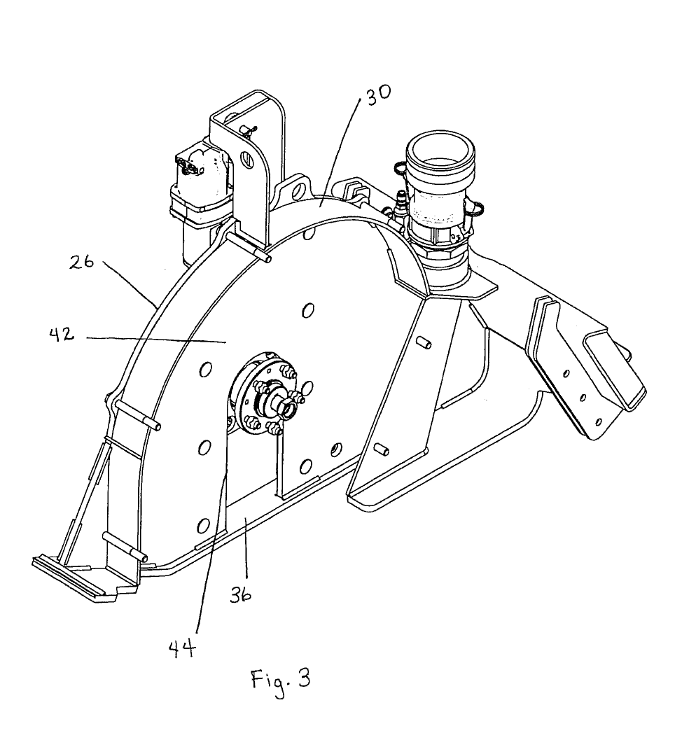

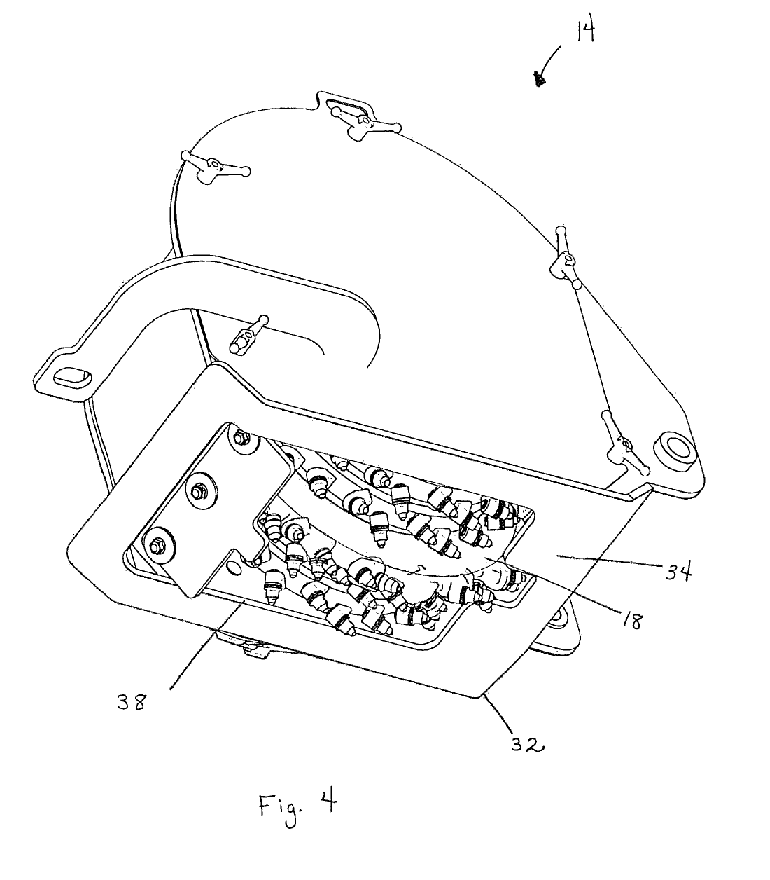

As best shown in FIGS. 3 and 4, the lower wall 32 has an outer surface 34 and an inner surface 36. An opening 38 is formed in the lower wall 32. The opening 38 extends between the lower wall's outer and inner surfaces 34, 36. The opening 38 is fully enclosed by the lower wall 32. Adjacent the opening 38, the lower wall's outer surface 34 is planar.

Providing a planar surface around the opening 38 enhances the degree of ground contact the housing 16 can maintain during a trenching operation. With good ground contact around a trench being formed, the housing 16 stabilizes the ground and produces a cleaner cut. Good ground contact also reduces escape of dust and debris from the housing 16.

The lower wall 32 may comprise a skid plate positioned to cover the lower wall's outer surface 34. The skid plate is formed from a strong and durable material, such as steel. When the housing 16 is lowered, the skid plate engages the ground to reduce wear on the housing 16. For ease of replacement, the skid plate preferably is removably mounted on the housing 16 via threaded connectors, such as bolts. When the skid plate is not used, the function of reducing wear may be accomplished by reinforcing the ground-engaging portion of the housing 16 with a hardened material.

As shown in FIGS. 1 and 3, the first side wall 26 has an outer surface 40 and an inner surface 42. A slot 44 is formed in the first side wall 26. The slot 44 extends between the first side wall's outer and inner surfaces 40, 42. Additionally, the housing 16 has a port 46 where the vacuum system 20 can attach to the housing 16 via the vacuum hose 22. Preferably, the port 46 is formed adjacent a site within the housing 16 where spoils accumulate during trenching.

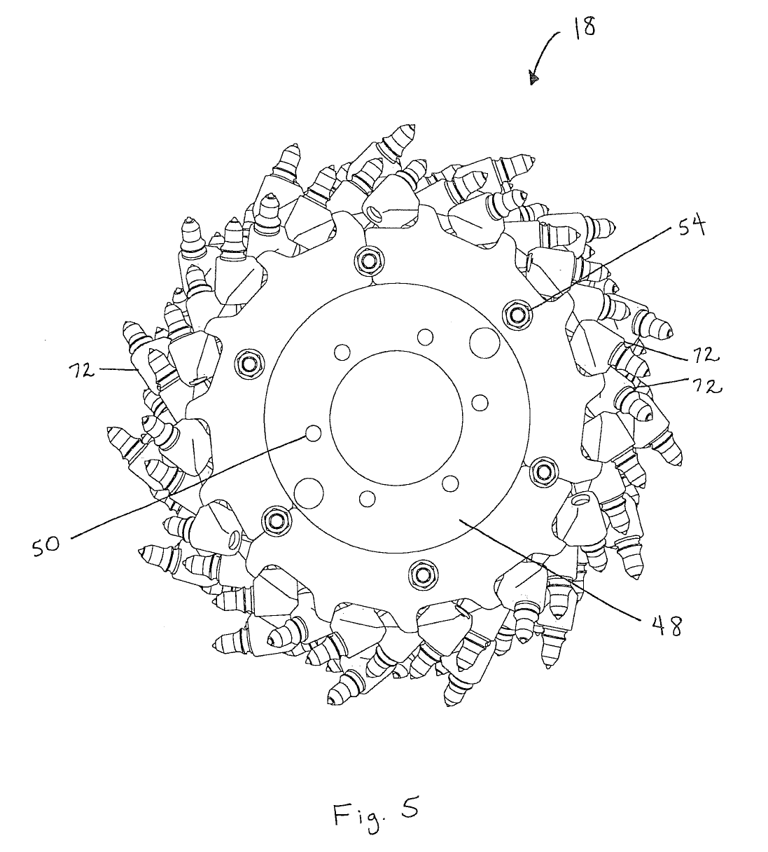

With reference to FIGS. 1, 2 and 4, the cutting assembly 18 is positioned within the housing 16 such that a portion of the cutting assembly 18 extends through the opening 38 in the lower wall 32. The cutting assembly 18 comprises a cutting wheel 48 formed from a strong and durable material, such as steel. As shown in FIG. 5, a plurality of openings 50o are formed in the cutting wheel 48. The openings 50 facilitate mounting the cutting wheel 48 on a motor via a connector, such as a hub.

With reference to FIGS. 5-7, the cutting wheel 48 is situated on a longitudinal axis. The cutting wheel 48 has a plurality of layers 52 in which each layer 52 has a cylindrical profile. Preferably, each layer 52 has a center of rotation located on the longitudinal axis. The wheel 48 and its layers 52 can be manufactured as a single piece, or the layers 52 can be formed separately and bound together with a plurality of connectors 54 to form the wheel 48. Each layer 52 may comprise a plurality of curved segments 56 joined together to form a ring. Each layer 52 is characterized by a cylindrical profile having a single diametrical dimension. Different layers may be characterized by profiles having different diametrical dimensions.

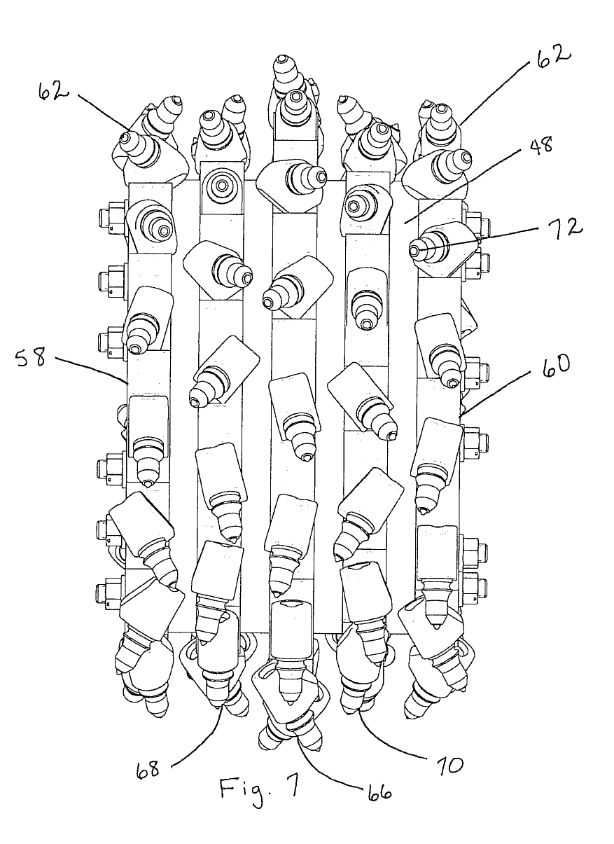

Referring to FIG. 7, the cutting wheel 48 has a pair of opposed first and second ends 58, 60. A pair of outer layers 62 are situated on the opposed ends 58, 60 of the cutting wheel 48, and three intermediate layers 66, 68, 70 are situated between the pair of outer layers 62. Preferably the diametrical dimension of at least one intermediate layer's profile is larger than the diametrical dimension of either outer layers' profiles. Also preferably, the pair of outer layers 62 have profiles of the same diametrical dimension. As shown in FIG. 7, a first intermediate layer 66 is characterized by a profile of a larger diametrical dimension, while a second intermediate layer 68, a third intermediate layer 70, and the outer layers 62 are characterized by profiles of a single smaller diametrical dimension.

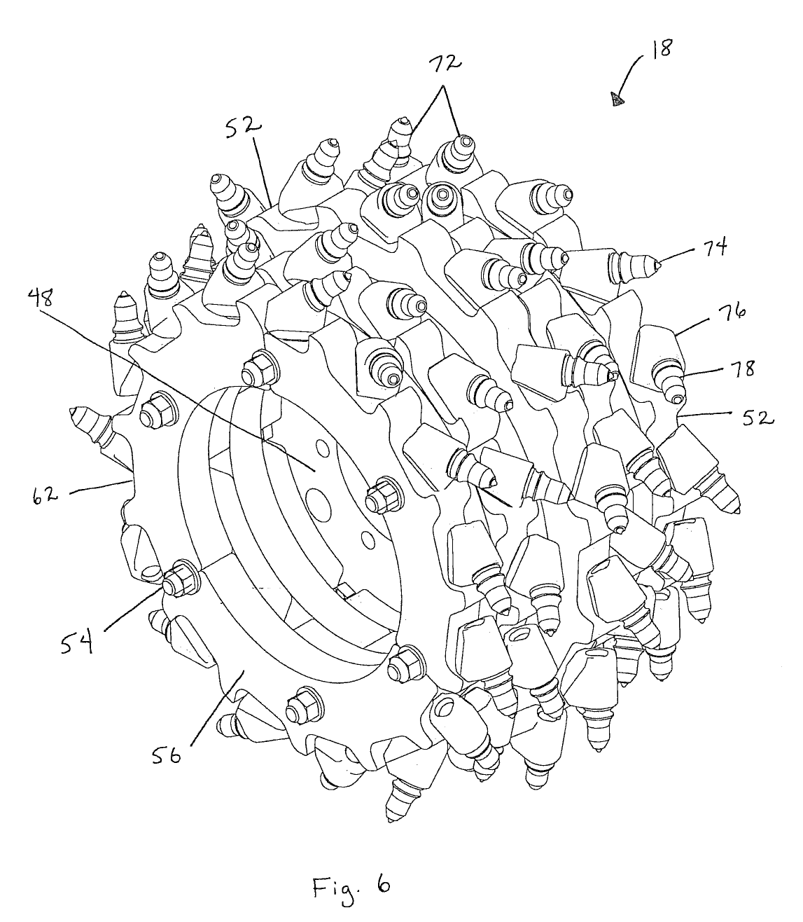

The cutting assembly 18 further comprises a plurality of teeth 72 positioned on the periphery of the cutting wheel 48. Preferably, the plurality of teeth 72 are mounted on each layer 52 of the cutting wheel 48. Any number of teeth 72 may be mounted on a particular layer 52. For example, one of the outer layers 62 shown in FIG. 6 has fifteen teeth 72. However, any suitable number of teeth 72 may be used.

The teeth 72 are formed from a strong and durable material, such as steel. The teeth 72 may be manufactured as a part of the cutting wheel 48 or the teeth 72 may be attached to the cutting wheel 50 by connectors, such as bolts, or by a fusion process, such as welding. Preferably, each tooth 72 has a tip 74 formed from diamond or carbide. In the embodiment shown in FIGS. 4-6, each tooth 72 comprises a base 76 and a rotating bit 78 supported on the base 76. Each base 76 is supported on one of the plurality of layers 52.

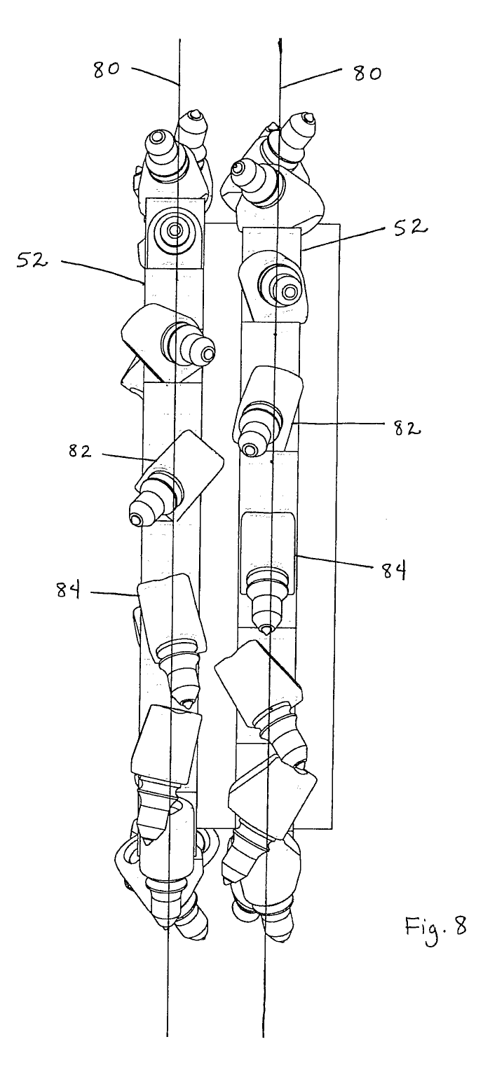

FIG. 8 shows two of the layers 52 traversed by respective cross planes 80 extending in parallel relationship. A first tooth 82 and a second tooth 84 are supported on each layer 52. An angle is formed between each tooth 82, 84 and the cross plane 80o of the layer 52 on which the tooth 82, 84 is supported. The first and second teeth 82, 84 are situated such that they extend at different angles relative to the respective layer's cross plane 8o. Returning to FIGS. 6 and 7, preferably, each of the teeth 72 are situated such that adjacent teeth 72 extend at different angles relative to the respective layer's cross plane. Also preferably, each of the teeth 72 are oriented such that the tip 74 of each tooth 72 is angled toward the direction of rotation when the cutting wheel 48 is rotated in a first direction about the longitudinal axis.

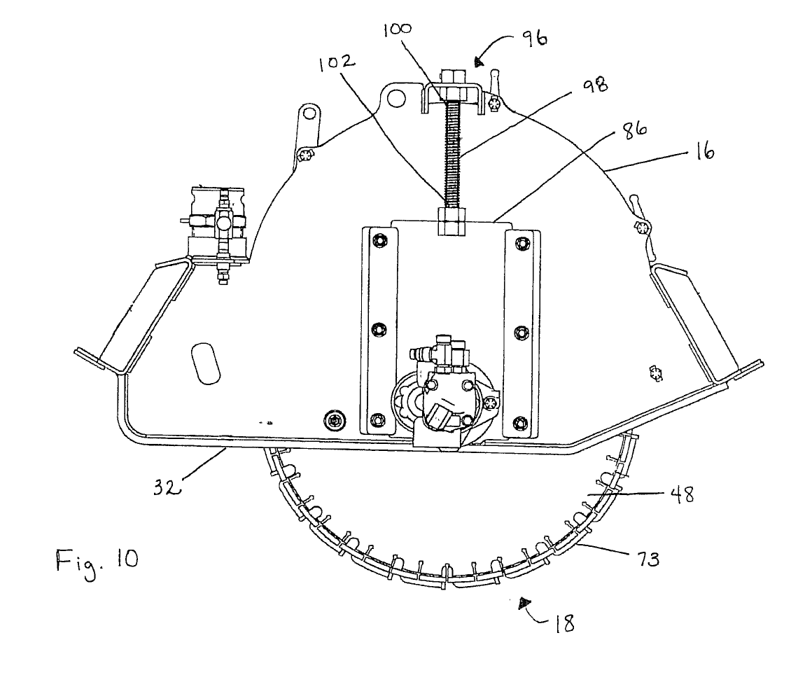

An additional type of tooth 72 that can be used is a polycarbonate diamond compact (PDC) cutter 73 as shown in FIG. 10. The PDC cutter 73 may cover the entire width of the layer 52. In one embodiment using PDC cutters 73, two adjacent layers 52 having profiles of larger diametrical dimension are situated intermediate a pair of eight layers 52 having profiles of smaller diametrical dimension.

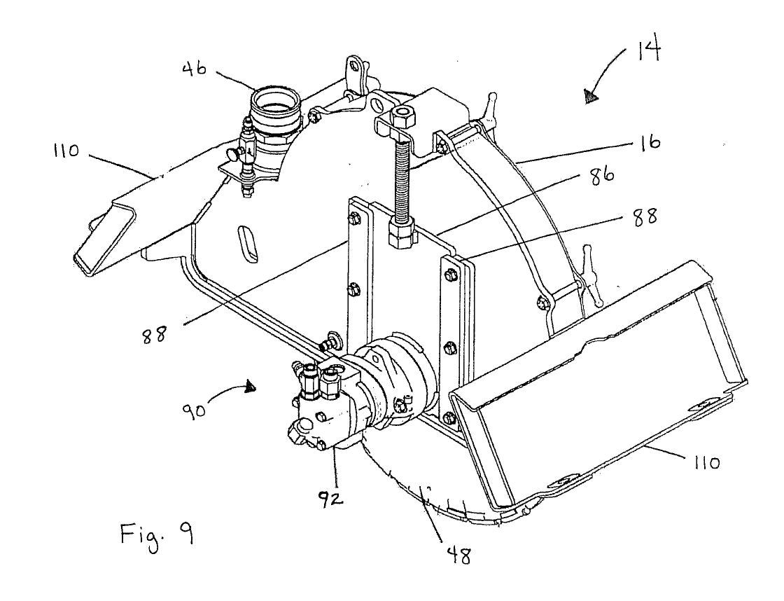

As shown in FIGS. 9-11, the trenching assembly 14 further comprises a plate 86 positioned over the slot 44. The plate 86 has an opening (not shown) that overlays the slot 44. A pair of guide elements 88 are connected to the housing 16 and positioned in parallel relationship on either side of the slot 44. The guide elements 88 support the plate 86 so that the plate 86 is in slidable engagement with the housing 16.

The apparatus further comprises a motor assembly 90 supported on the plate 86. The motor assembly 90 comprises a motor 92 that powers rotation of the cutting wheel 48. A portion of the motor assembly 90 extends into the housing cavity through the plate opening and the slot 44. This projecting portion of the motor assembly 90 is mounted to the cutting assembly 18 within the housing cavity.

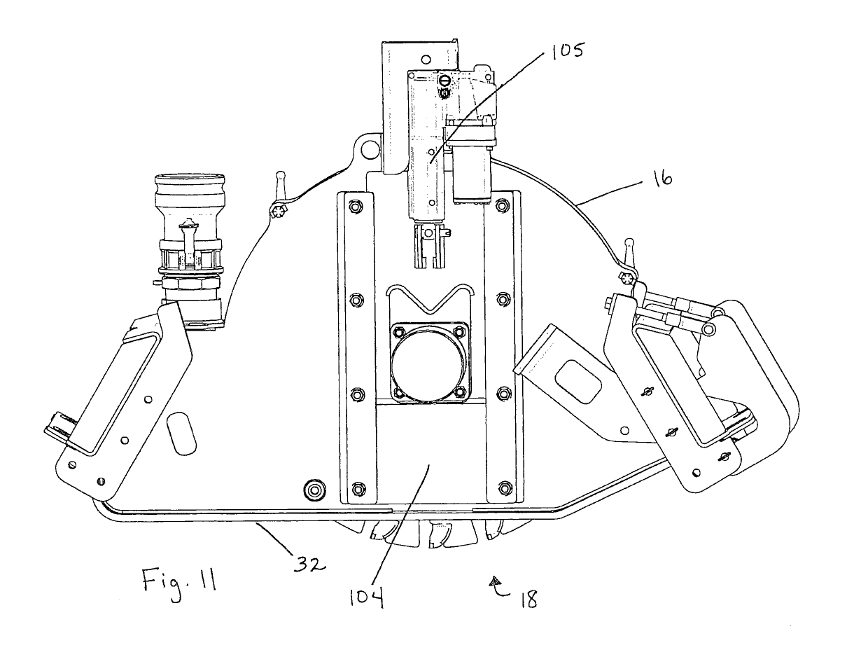

As shown in FIG. 10, the plate 86 is in a lowered position in which the slot 44 is entirely covered by the plate 86. In contrast, as shown in FIG. 11, the plate 86 is in a raised position in which a portion of the slot 44 is not covered by the plate 86. A depth adjustment device adjusts the position of the plate 86 relative to the housing 16. As the plate 86 is raised and lowered, the supported motor assembly 90, and its connected cutting assembly 18, are raised and lowered as well. The depth adjustment device may comprise a linear actuator, such as a jackscrew, a hydraulic cylinder, or a rack and pinion.

In FIGS. 9-10, the depth adjustment device comprises a jackscrew 96. The jackscrew 96 has a leadscrew 98 having opposed first and second ends 100, 102. A first end too of the leadscrew 98 is attached to the housing 16 and a second end 102 of the leadscrew 98 is attached to the plate 86. Turning the leadscrew 98 in a first direction raises the plate 86 relative to the housing's lower wall 32, and turning the leadscrew 98 in the opposite direction lowers the plate 86 relative to the housing's lower wall 32. As shown in FIG. 11, the depth adjustment device comprises a hydraulic cylinder 105.

With reference to FIGS. 10 and 11, a cover 104, such as a flap for the slot 44 is shown. Preferably, the cover 104 is made from a flexible material, such as rubber or plastic. The cover 104 may attach to the housing 16. In another embodiment, the cover 104 attaches to the plate 86. When the plate 86 is in a raised position shown in FIG. 11, the cover 104 is extended over the portion of the slot 44 that is not covered by the plate 86. When the plate 86 is in a lowered position shown in FIG. 9, the cover 104 is retracted.

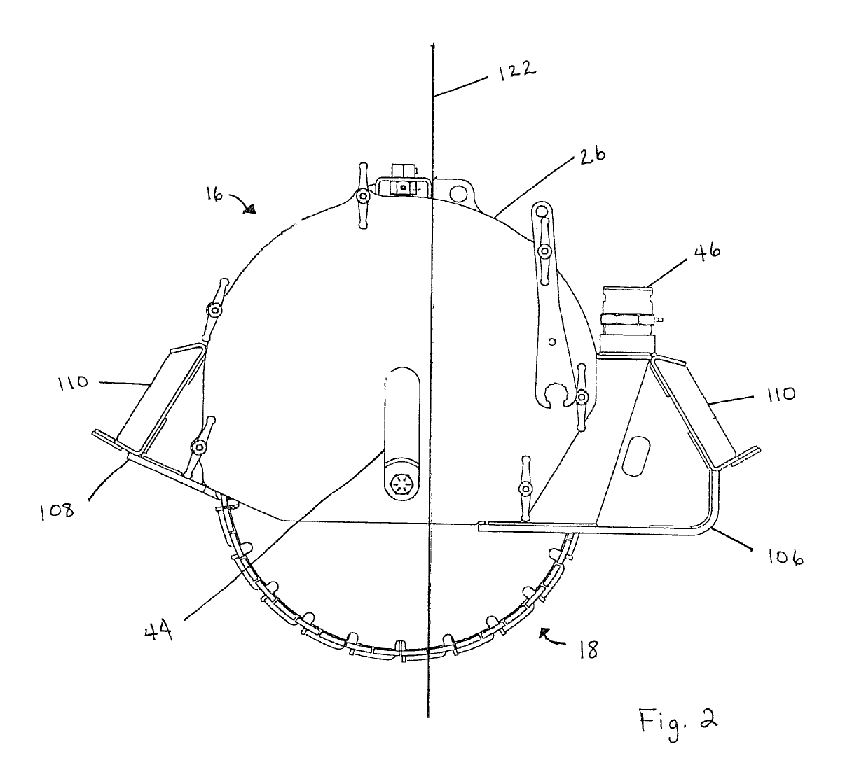

Returning to FIGS. 1 and 2, the housing 16 has opposed first and second ends 106, 108. A pair of couplers 110 are situated on each of the housings ends 106, 108. In one embodiment, each coupler 110 comprises a receiver plate having a support panel 114, an upper flange 116, and a lower flange 118 in which the flanges 116, 118 project from the support panel 114. Preferably, the upper flange 116 and the support panel 114 define an included angle of 90 degrees or less. Also preferably, a plurality of openings 120 are formed in the lower flange 118.

The work machine 12 may attach to the coupler 110 by a hitching mechanism. The hitching mechanism may comprise a mount plate that hooks the upper flange 116 and latches onto the lower flange 118 via a plurality of pins extending through the plurality of openings 120. Preferably, the pins are spring-loaded. When the spring-loaded pins are positioned over the openings 120, the pins automatically extend through the openings 120.

Continuing with FIG. 2, a vertical plane 122 traverses the housing 16 and the cutting assembly 18. The pair of couplers 110 are formed as mirror images with respect to the plane 122. Mirror image couplers 110 on opposed ends of the housing 16 are helpful on trenching jobs that require alternating between pushing and pulling the trenching assembly 14.

The couplers 110 allow the trenching assembly 14 to be disconnected from one coupler 110 and re-connected at the other coupler 110 when transition from pushing to pulling is required. The work machine 12 may attach to one of the couplers 110 so that the trenching assembly 14 is pushed in a first direction. Alternatively, the work machine 12 may attach to the other coupler 110 so that the trenching assembly 14 is pulled in the first direction. Positioning couplers 110 on both ends of the housing 16 is advantageous so that the trenching assembly 14 can be pushed or pulled in a given direction without changing the orientation of the cutting wheel 48 with respect to the trench. Keeping the cutting wheel 48 in the same orientation with respect to the trench is particularly desirable when the cutting wheel 48 is configured for rotation in a single direction.

FIG. 12 shows the system to in which the trenching assembly 14 is used to form a t-shaped trench 124 in a surface of the ground 126. The trenching assembly 14 is attached to the work machine 12 and positioned on the ground 126. The motor assembly 90 rotates the cutting assembly 18 while the work machine 12 pulls the trenching assembly 14 to form the trench 124. The depth of the trench 124 is adjusted by raising or lowering the cutting assembly 18 via the depth adjustment device.

As the cutting wheel 48 breaks through the ground 126, spoils are formed in the trench 124 and turned up into the housing 16. Maintaining the lower wall 32 of the housing 16 in contact with the ground 126 helps contain the spoils within the housing 16. Likewise, the cover 104 over the slot 44 in the housing 16 helps to contain spoils. The spoils are carried away by the vacuum system 20. Containing the spoils and vacuuming them away are beneficial to clean the trench 124 and to reduce the amount of dust and debris that escapes into the ambient air.

Changes may be made in the construction, operation and arrangement of the various parts, elements, steps and procedures described herein without departing from the spirit and scope of the invention as described in the following claims.

1. An apparatus, comprising:
a housing having a ground-engaging base, in which an opening is formed in the base; and
a cutting assembly at least partially positioned within the housing and comprising:
a cutting wheel having a plurality of layers of cylindrical profile in which at least two of the layers have profiles with different diametrical dimensions; and
a plurality of teeth extending from the periphery of the cutting wheel in which at least some of the teeth are positioned on different layers.

2. The apparatus of claim 1 in which the layers are arranged such that a layer having a profile of larger diametrical dimension is situated intermediate a pair of layers having profiles of smaller diametrical dimension.

3. The apparatus of claim 1 in which the cutting wheel has a pair of opposed ends and in which the plurality of layers further comprise:
a pair of outer layers in which one outer layer is situated adjacent each end; and
an inner layer situated intermediate the outer layers.

4. The apparatus of claim 3 in which the profile of the inner layer has a larger diametrical dimension than the profile of either outer layer.

5. The apparatus of claim 1 in which the teeth extend through the opening formed in the base.

6. The apparatus of claim 1 in which at least two layers are traversed by respective cross planes extending in parallel relationship, each of the at least two layers supporting at least two teeth that extend at different angles relative to that layer's cross plane.

7. A system, comprising:
the apparatus of claim 1; and
a t-shaped trench formed in the ground and within which the cutting wheel is partially positioned.

8. An apparatus, comprising:
a housing having a pair of first and second spaced side walls, each side wall having an outer surface and an inner surface, the first side wall having an outer slot opening formed in the outer surface, an inner slot opening formed in the inner surface, and a slot extending through the first side wall between the outer slot opening and the inner slot opening;
a plate adjustably positioned over the outer slot opening, the plate characterized by a raised position in which the plate uncovers a portion of the outer slot opening, and a lowered position in which the plate covers the portion of the outer slot opening;
a motor assembly supported on the plate;
a cutting assembly connected to the motor assembly and at least partially positioned within the housing and comprising a cutting wheel having a plurality of layers of cylindrical profile in which at least two of the layers have profiles with different diametrical dimensions; and
a retractable cover in which the cover extends over at least a portion of the outer slot opening when the plate is in the raised position.

9. The apparatus of claim 8, the cutting assembly further comprising:
a plurality of teeth extending from the periphery of the cutting wheel in which at least some of the teeth are positioned on different layers.

10. The apparatus of claim 8 in which the housing has a lower surface having an opening and in which the cutting assembly extends through the lower surface opening.

11. The apparatus of claim 8 in which the cover is flexible.

12. The apparatus of claim 8, further comprising:
a device configured to move the plate relative to the housing and to maintain the plate in a fixed position at any selected point on its path of travel.

13. The apparatus of claim 8, further comprising:
a vacuum system having a hose; and
a port formed in the housing in which the hose connects the housing to the vacuum system via the port.

14. The apparatus of claim 10 in which the lower surface comprises:
a skid plate.
